(19) United States
(12) Patent Application Publication
(10) Pub. No.: US 2015/0130794 A1
(43) Pub. Date: May 14, 2015

(54) ROBOT SIMULATOR, ROBOT SIMULATION METHOD, ROBOT SIMULATION PROGRAM

(71) Applicant: Kabushiki Kaisha Yaskawa Denki, Kitakyushu-shi (JP)

(72) Inventor: Shinichi KATSUDA, Kitakyushu-shi (JP)

(73) Assignee: KABUSHIKI KAISHA YASKAWA DENKI, Kitakyushu-shi (JP)

(21) Appl. No.: 14/525,257

(22) Filed: Oct. 28, 2014

(30) Foreign Application Priority Data
Nov. 11, 2013 (JP) 2013-233381

(51) Int. Cl. G06T 13/40; G06T 19/20

(52) U.S. Cl. CPC G06T 13/40; G06T 19/20; G06T 2219/2008; G06T 2219/2016
USPC 345/419

(57) ABSTRACT

A robot simulator includes an image generator and a display controller. The image generator is configured to generate a three-dimensional robot image representing a movement to be taught to a robot. The display controller is configured to combine a two-dimensional image representing an environment of the robot with the three-dimensional robot image generated by the image generator so as to obtain a combined image, and configured to control a display to display the combined image.

### CROSS-REFERENCE TO RELATED APPLICATIONS

The present application claims priority under 35 U.S.C. §119 to Japanese Patent Application No. 2013-233381, filed Nov. 11, 2013. The contents of this application are incorporated herein by reference in their entirety.

### BACKGROUND

1. Field of the Invention

The embodiments disclosed herein relate to a robot simulator, a robot simulation method, and a robot simulation program.

2. Discussion of the Background

Japanese Patent No. 4441409 discloses a robot simulator that generates an image representing an environment of a robot or a movement to be taught to the robot and that displays the image on a display so as to check how the robot is going to move. The image displayed on the robot simulator is preferably a three-dimensional image rather than a two-dimensional image in view of providing a closer-to-real image of the movement of the robot.

### SUMMARY

According to one aspect of the present disclosure, a robot simulator includes an image generator and a display controller. The image generator is configured to generate a three-dimensional robot image representing a movement to be taught to a robot. The display controller is configured to combine a two-dimensional image representing an environment of the robot with the three-dimensional robot image generated by the image generator so as to obtain a combined image, and configured to control a display to display the combined image.

According to another aspect of the present disclosure, a robot simulation method includes generating a three-dimensional robot image representing a movement to be taught to a robot. A two-dimensional image representing an environment of the robot is combined with the three-dimensional robot image so as to obtain a combined image, and a display is controlled to display the combined image.

According to the other aspect of the present disclosure, a robot simulation program is for causing a computer to execute processing including generating a three-dimensional robot image representing a movement to be taught to a robot. A two-dimensional image representing an environment of the robot is combined with the three-dimensional robot image so as to obtain a combined image, and a display is controlled to display the combined image.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 illustrates a real EFEM according to an embodiment;

FIG. 2 is a block diagram illustrating a robot simulator according to the embodiment;

FIG. 3 illustrates an input screen according to the embodiment;

FIG. 4 illustrates an exemplary simulation screen according to the embodiment;

FIG. 5 illustrates another exemplary simulation screen according to the embodiment;

FIG. 6 is a flowchart of processing performed by a controller of the robot simulator according to the embodiment;

FIG. 7 illustrates a simulation image according to modification 1 of the embodiment;

FIG. 8 illustrates another simulation image according to modification 1 of the embodiment;

FIG. 9 illustrates another simulation image according to modification 1 of the embodiment; and

FIG. 10 illustrates a simulation image according to modification 2 of the embodiment.

### DESCRIPTION OF THE EMBODIMENTS

A robot simulator, a robot simulation method, and a robot simulation program according to an embodiment will be described in detail below by referring to the accompanying drawings. The following embodiment is provided for exemplary purposes only and is not intended to limit the present invention.

First, a real robot system simulated by a robot simulator according to this embodiment will be described. Then, the robot simulator according to this embodiment will be described. The following description will exemplify the robot system with such a robot system that a robot disposed inside an Equipment Front End Module (EFEM) conveys semiconductor wafers. This, however, should not be construed as limiting the robot system according to this embodiment.

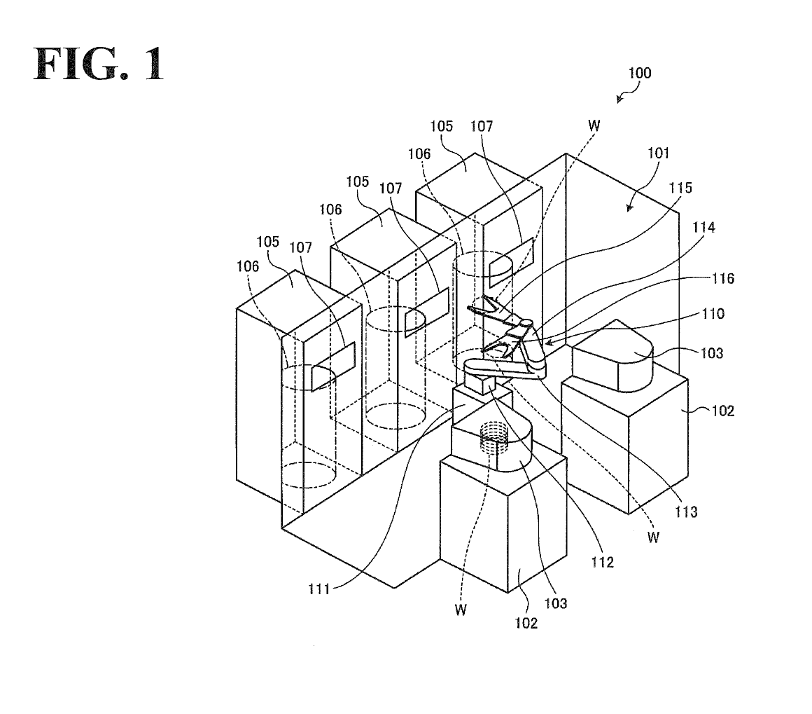

FIG. 1 illustrates a real EFEM 100 according to the embodiment. For ease of understanding of the internal configuration of the EFEM 100, FIG. 1 illustrates the EFEM 100 with its two adjacent walls on the lower side of the paper surface and the ceiling removed.

As illustrated in FIG. 1, the EFEM 100 includes a clean room 101. The clean room 101 is kept clean on the inside. The EFEM 100 also includes a plurality of processing chambers 105 and tables 102. The plurality of processing chambers 105 are disposed next to the clean room 101. On each of the tables 102, a FOUP (Front Open Unified Pod) 103 is placed. The FOUP 103 is used to take in and out a semiconductor wafer W. While in this embodiment three processing chambers 105 and two tables 102 are disposed, this should not be construed as limiting the number of the processing chambers 105 and the number of the tables 102.

The FOUP 103 placed on one table 102 stores a plurality of (for example, 25) semiconductor wafers W that, for example, have not undergone processing yet. The FOUP 103 placed on the other table 102 is currently empty and is for the purpose of storing semiconductor wafers W that, for example, have undergone processing.

Each of the processing chambers 105 includes a wafer stage 106 inside each processing chamber 105. On the wafer stage 106, a semiconductor wafer W to be processed is to be placed. Inside the processing chamber 105, a processing device, not illustrated, is disposed to perform predetermined processing with respect to the semiconductor wafer W. Examples of the processing device include a sputtering device, a chemical vapor deposition (CVD) device, an etching device, an ashing device, and a washing device. These processing devices are provided for exemplary purposes only.

The processing chamber 105 also includes a conveyance window 107, which communicates with the clean room 101. The conveyance window 107 is used to bring the semiconductor wafer W from the clean room 101 into the processing chamber 105, and to take out the semiconductor wafer W from the processing chamber 105 to the clean room 101. During the processing of the semiconductor wafer W, the conveyance window 107 is closed by a shutter, not illustrated.

In the center of the clean room 101, a robot 110 is disposed to convey the semiconductor wafer W. An example of the robot 110 is a horizontal multi-articular robot. This horizontal multi-articular robot has a single arm and rotates in a horizontal direction about a vertical axis. Specifically, the robot 110 includes a body 112, a first arm 113, a second arm 114, a first hand 115, and a second hand 116. The body 112 is disposed on a base 111.

The body 112 includes an elevating mechanism inside the body 112, and supports the base end of the first arm 113 in a horizontally rotatable manner and in a vertically elevatable manner. The first arm 113 supports at its distal end the base end of the second arm 114 in a horizontally rotatable manner. The second arm 114 supports at its distal end the base ends of the first hand 115 and the second hand 116 in a horizontally rotatable manner.

The first arm 113, the second arm 114, the first hand 115, and the second hand 116 are rotatable relative to each other, and rotate using a mechanism made up of a motor, a reducer, and other elements.

The robot 110 elevates the body 112 and turns the first arm 113, the second arm 114, the first hand 115, and the second hand 116 so as to position the distal ends of the first hand 115 and the second hand 116 at respective target positions (hereinafter referred to as “access point(s)”).

In this manner, the robot 110 is capable of conveying the semiconductor wafer W that has not undergone processing from the FOUP 103 to the wafer stage 106 inside the processing chamber 105, and conveying the semiconductor wafer W that has undergone the processing from the processing chamber 105 to the inside of the FOUP 103.

While in this embodiment the robot 110 has a single arm, it is also possible to use a robot with equal to or more than two arms in the clean room 101. A two-arm robot is capable of performing two kinds of work simultaneously. For example, one arm may take out the semiconductor wafer W at a predetermined conveyance position, while the other arm may take in a new semiconductor wafer W to the conveyance position.

The robot 110 is capable of conveying the semiconductor wafer W by being taught in advance information such as coordinates indicating the access points, the elevation position of the body 112, and the rotation angles of the first arm 113, the second arm 114, the first hand 115, and the second hand 116.

When, however, the information taught to the robot 110 contains, for example, an error, then objects existing in the environment may interfere with the first arm 113, the second arm 114, the first hand 115, and the second hand 116 in actual work.

In view of this, prior to actual movement of the robot 110, the robot simulator according to this embodiment generates an image representing the environment of the robot 110 and a movement to be taught to the robot 110, and displays on a display a simulation image of the robot 110 that is going to perform the work.

Here, the simulation image is preferably a three-dimensional image rather than a two-dimensional image in view of providing a closer-to-real image of the movement of the robot 110. For a robot simulator, however, representing both the environment of the robot 110 and the robot 110 in a three-dimensional image increases the load necessary for image generation.

Additionally, representing both the robot and the environment of the robot in a three-dimensional image requires a large number of time-consuming steps to prepare a three-dimensional model to serve as data for the three-dimensional image at the stage of examining the robot 110 and its environment.

In view of this, the robot simulator according to this embodiment displays a simulation image that makes it easier to have an image of an actual movement of the robot while reducing the processing load necessary for image generation. A configuration and operation of the robot simulator according to this embodiment will be described below.

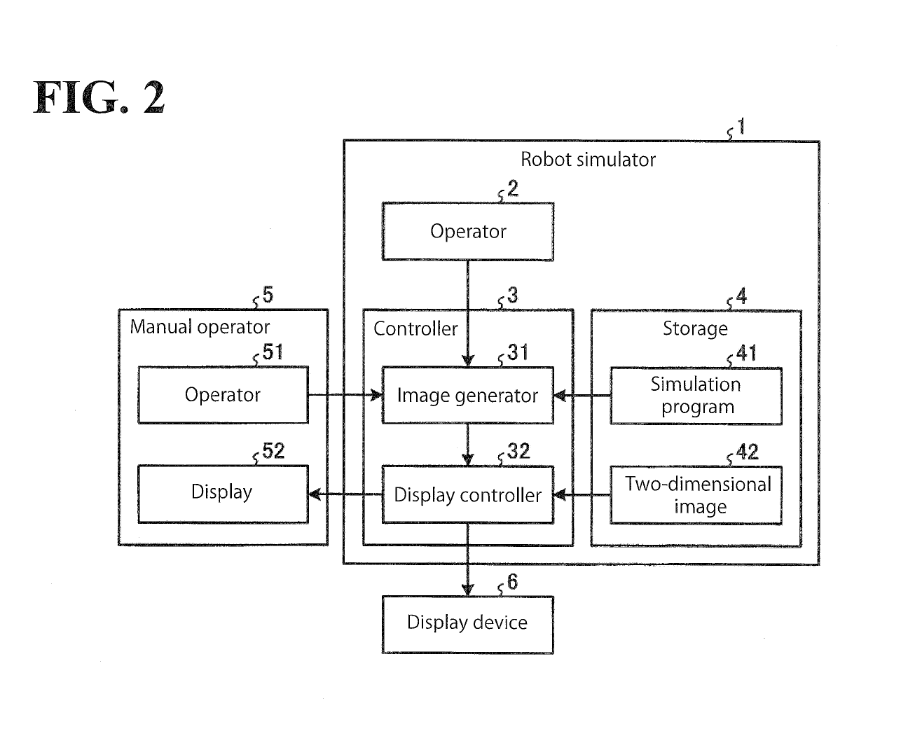

FIG. 2 is a block diagram illustrating a robot simulator 1 according to this embodiment. As illustrated in FIG. 1, the robot simulator 1 includes an operator 2, a controller 3, and a storage 4. The storage 4 stores a simulation program 41 and a two-dimensional image 42.

The simulation program 41 is software executed by the controller 3 to simulate work performed by the robot 110. The two-dimensional image 42 is two-dimensional image information indicating an environment of the robot 110. The two-dimensional image 42 stored in the storage 4 indicates a plurality of kinds of environments corresponding to respective types of the EFEM 100.

The controller 3 is coupled to a manual operator 5 and a display device 6. The manual operator 5 and the display device 6 are separate from the robot simulator 1. The display device 6 is a display that displays a simulation image input from the robot simulator 1. The manual operator 5 is a programming pendant used to teach work that the robot 110 is going to perform.

The manual operator 5 includes an operator 51 and a display 52. The operator 51 of the manual operator 5 receives an operation of input of teaching information related to work that the robot 110 is going to perform. For example, the operator 51 receives an operation of input of teaching information that includes coordinates of the access points that the first hand 115 and the second hand 116 have access while the robot 110 is at work. Then, the operator 51 outputs the input teaching information to the controller 3 of the robot simulator 1.

The display 52 of the manual operator 5 is a display that displays a simulation image of the robot 110 input from the robot simulator 1. Thus, the robot simulator 1 is capable of displaying the generated simulation image both on the display 52 of the manual operator 5 and the display device 6.

The operator 2 of the robot simulator 1 is an information input device such as a keyboard and a mouse. The operator 2 receives an operation of input of various kinds of information necessary for generation of the simulation image. Such information includes parameters related to the robot 110 and commands to the robot simulator 1.

The operator 2 may be any other information input device than a keyboard and a mouse. Other possible examples include a display equipped with a touch panel function. The operator 2 outputs the input information to the controller 3.

An example of the controller 3 is an operation device that includes a CPU (Central Processing Unit) and a graphic board. The controller 3 includes an image generator 31 and a display controller 32. The image generator 31 loads the simulation program 41 from the storage 4, applies the information input from the operator 2 of the robot simulator 1 and the operator 51 of the manual operator 5 to the simulation program 41, and executes the resulting simulation program 41.

Thus, the image generator 31 generates the robot 110's three-dimensional image (which includes a still picture and a movie) representing a movement to be taught to the robot 110. Then, the image generator 31 outputs the robot 110's three-dimensional image thus generated to the display controller 32.

The display controller 32 combines the robot 110's three-dimensional image input from the image generator 31 with the two-dimensional image 42 loaded from the storage 4 so as to generate a simulation image. That is, in the simulation image generated by the display controller 32, the robot 110 is described as performing work three-dimensionally in a two-dimensional area of the EFEM 100.

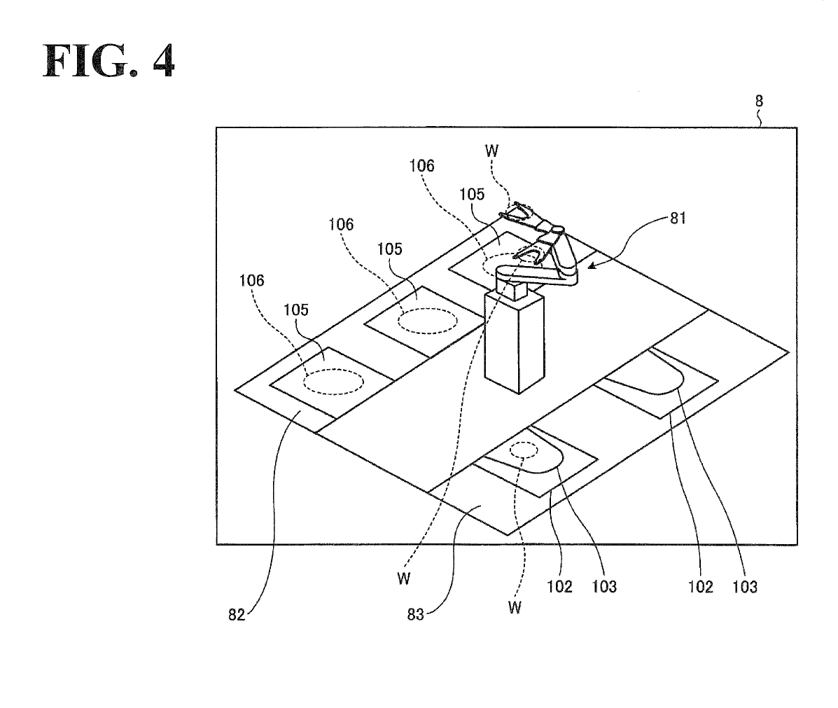

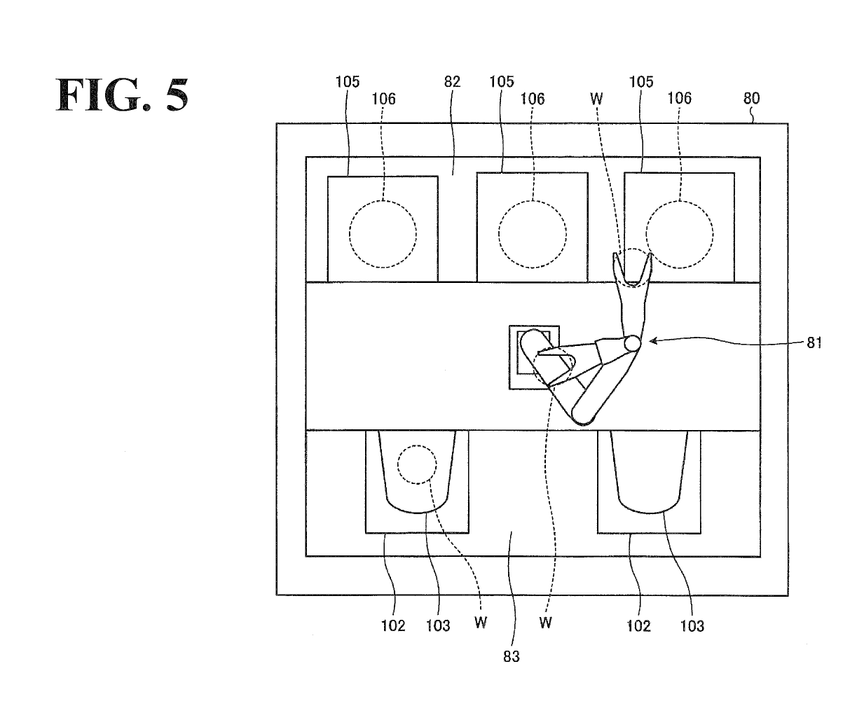

Then, the display controller 32 outputs the generated simulation image to the display 52 of the manual operator 5 and to the display device 6 so as to control the display 52 and the display device 6 to display the simulation image. Examples of the simulation image will be described later by referring to FIGS. 4 and 5.

Thus, the robot simulator 1 displays a simulation image in which the robot 110 is described as performing work three-dimensionally. This makes it easier to have an image of an actual movement of the robot 110 than with a two-dimensional image of the robot 110.

Additionally, since the environment of the robot 110 need not be described dynamically, the robot simulator 1 represents the environment of the robot 110 two-dimensionally in the simulation image. Thus, the robot simulator 1 reduces the processing load necessary for image representation as compared with representing all of the EFEM 100 in a three-dimensional image.

These advantages will be readily appreciated by a user of the robot 110 illustrated in FIG. 1, which is a horizontal multi-articular used in many semiconductor production apparatuses, since the user only needs to examine the movement of the robot 110 on a horizontal plane.

That is, the robot simulator 1 may not necessarily display an accurate two-dimensional image (plan view) of the environment. Instead, it is possible to display, for example, a rough sketch of the environment or a plan view of the environment solely with the addition of dimensions. This ensures necessary and sufficient checking or examination of movement.

Thus, the user only needs to prepare a rough sketch of the environment or a plan view of the environment solely with the addition of dimensions, and to store the rough sketch or the plan view in the robot simulator 1. This ensures simulation preparation without a large number of time-consuming preparation steps.

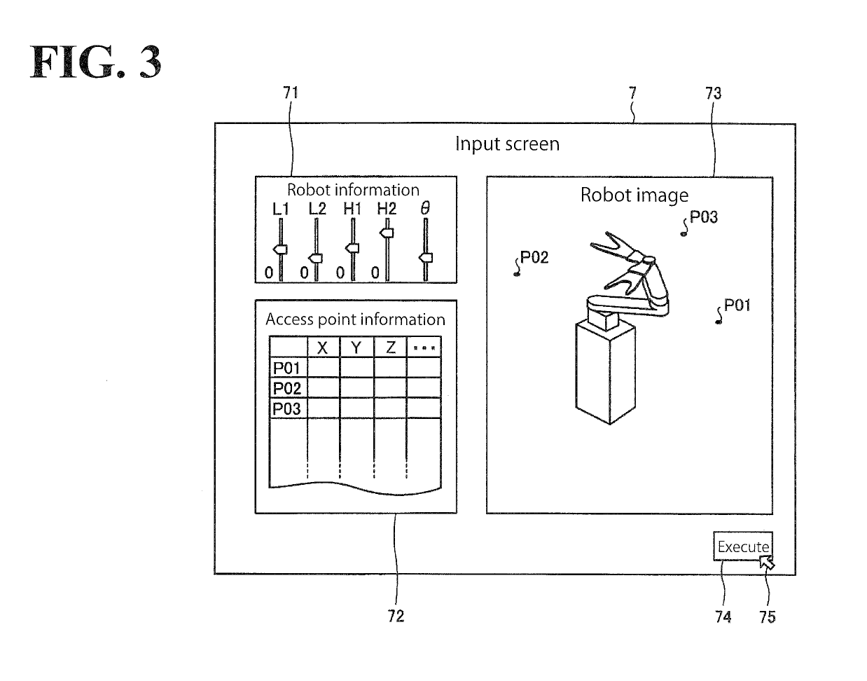

Next, by referring to FIG. 3, description will be made with regard to an input screen that the robot simulator 1 displays to show various kinds of information. FIG. 3 illustrates an input screen according to this embodiment. As illustrated in FIG. 3, prior to a simulation, the robot simulator 1 first displays an input screen 7 on the display 52 of the manual operator 5 and on the display device 6.

The input screen 7 includes a robot information input window 71, an access point information input window 72, a robot image window 73, and an execution button 74. The robot information input window 71 is a display area to display parameters of the robot 110 input from the operator 51 of the manual operator 5 or the operator 2 of the robot simulator 1.

As used herein, the parameters of the robot 110 refer to information indicating specifications, performance, and other properties of the robot 110. Specifically, examples of the parameters include, but are not limited to, the length, L1, of the first arm 113, the length, L2, of the second arm 114, the height position, H1, of the first hand 115, the height position, H2, of the second hand 116, and the rotation angle, θ, of the first arm 113.

It is noted that the pieces of information listed above are part of the parameters of the robot 110 to be input into the robot simulator 1. Upon input of the parameters of the robot 110, the image generator 31 generates a three-dimensional robot image to which the input parameters are applied, and displays the three-dimensional robot image within the robot image window 73.

The access point information input window 72 is a display area to display the coordinates of the access points input from the operator 51 of the manual operator 5 or the operator 2 of the robot simulator 1. For example, upon input of coordinates of access points P01, P02, and P03, the image generator 31 displays the access points P01, P02, and P03 within the robot image window 73.

After completion of input of the various kinds of information, the execution button 74, which is within the input screen, is clicked on using a cursor 75. Then, the display controller 32 combines the robot 110's three-dimensional image with the two-dimensional image 42, which represents the environment of the robot 110, so as to obtain a simulation image, and displays the simulation image.

In this embodiment, the manual operator 5 includes the operator 51 and the display 52. The operator 51 is used to input various kinds of information necessary for a simulation. The display 52 displays a simulation image. This configuration, however, should not be construed as limiting the configuration of the manual operator 5.

Another possible example is that the manual operator 5 is not provided with the display 52. In this case, the manual operator 5 serves as an input device that inputs into the robot simulator 1 teaching information of a movement to be taught to the robot 110 and various kinds of information necessary for a simulation. In this case, the simulation image is displayed by the display device 6.

The manual operator 5 may include the operator 51 and a display 52 without the function to display the simulation image. In this case, the display 52 may display, for example, text information of the various kinds of information input from the operator 51. Then, the simulation image may be displayed on the display device 6.

The robot simulator 1 is capable of performing a simulation without the manual operator 5. In this case, the various kinds of information necessary for the simulation may be input from the operator 2. The simulation image may be displayed on the display device 6.

Next, examples of the simulation image according to this embodiment will be described by referring to FIGS. 4 and 5. FIG. 4 illustrates an exemplary simulation image 8 according to this embodiment, and FIG. 5 illustrates an exemplary simulation image 80 according to this embodiment. In the following description, like reference numerals designate corresponding or identical elements throughout FIGS. 1, 4, and 5, and these elements will not be elaborated.

When a simulation starts, the display controller 32 displays a simulation image 8 as illustrated in FIG. 4. Specifically, the display controller 32 displays a three-dimensional image 81 of the robot 110, and lays two-dimensional images 82 and 83 over the surface on which the robot 110 is installed in the simulation image 8. The two-dimensional images 82 and 83 each represent an environment of the robot 110.

Here, the display controller 32 displays the three-dimensional image 81 of the robot 110 as viewed from a perspective. In accordance with the viewpoint employed in the three-dimensional image 81 of the robot 110, the display controller 32 changes the top view of the environment and displays a plan of the environment as viewed from a perspective.

Thus, the robot simulator 1 displays the three-dimensional image 81 of the robot 110 without the walls of the EFEM 100 and other obstacles to the movement checking of the robot 110. This makes it easier to have an image of an actual movement of the robot 110.

Additionally, the robot simulator 1 represents the environment of the robot 110 in the two-dimensional images 82 and 83. Thus, the robot simulator 1 makes it easier to have an image of positional relationship that the robot 110 at work has with the processing chambers 105 and the FOUPs 103 while reducing the processing load necessary for image generation.

When the operator 51 of the manual operator 5 or the operator 2 of the robot simulator 1 receives an operation to change the viewpoint, the display controller 32 changes the viewpoint in the simulation image 8 and displays the simulation image 80.

For example, when the operator 51 of the manual operator 5 or the operator 2 of the robot simulator 1 receives an operation to change the viewpoint of the EFEM 100 to a vertically upward viewpoint, the display controller 32 changes the viewpoint employed in the three-dimensional image 81 of the robot 110 to a vertically upward viewpoint and changes the viewpoint employed in the two-dimensional images 82 and 83, which represent the environment, to a vertically upward viewpoint, as illustrated in FIG. 5.

Thus, the robot simulator 1 facilitates checking for interference of the robot 110 represented by the three-dimensional image 81 with the environment such as the processing chambers 105 and the FOUPs 103. When an interference occurs between the robot 110 and the environment in the simulation images 8 and 80, the robot simulator 1 may make a notification of the interference by making sound or an indication.

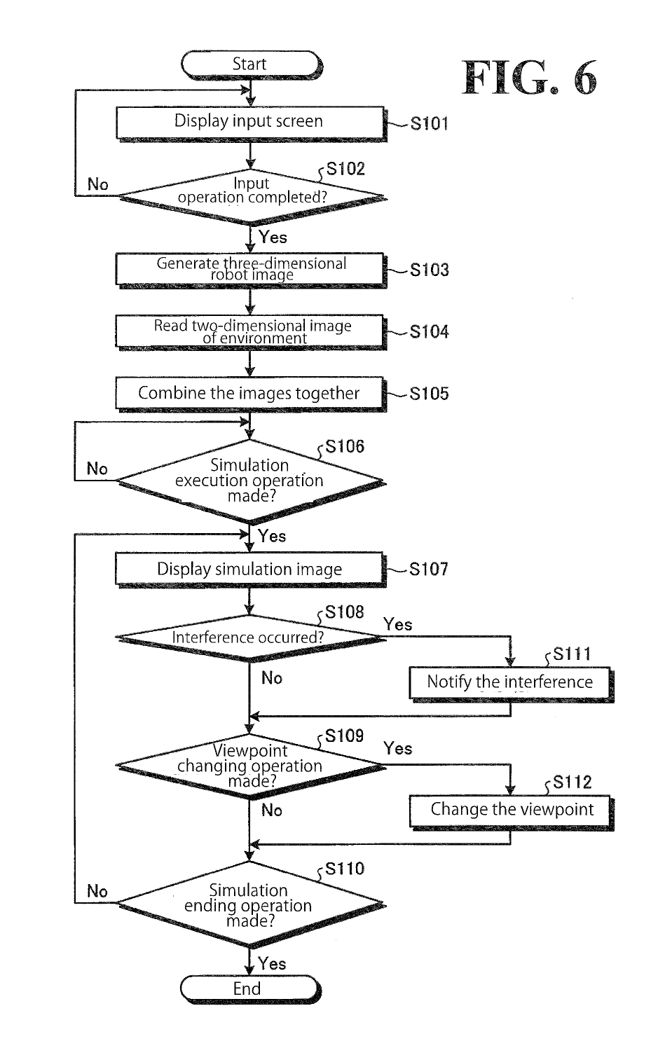

Next, by referring to FIG. 6, description will be made with regard to processing performed by the controller 3 of the robot simulator 1 according to this embodiment. FIG. 6 is a flowchart of the processing performed by the controller 3 of the robot simulator 1 according to this embodiment.

As illustrated in FIG. 6, the controller 3 first displays the input screen (step S101). Then, the controller 3 determines whether an operation of input of the various kinds of information necessary for the simulation has been completed (step S102). When the controller 3 determines that the operation of input has not been completed (No at step S102), the processing moves to step S101.

When the operation of input of the various kinds of information concurs in the meantime, the controller 3 displays the input various kinds of information on the input screen. When the controller 3 determines that the operation of input of the various kinds of information has been completed (Yes at step S102), the controller 3 generates the three-dimensional image 81 of the robot 110 to which the input parameters are applied (step S103).

Next, the controller 3 reads the two-dimensional images 82 and 83 of the environment of the robot 110 from the storage 4 (step S104), and combines the three-dimensional image 81 of the robot 110 with the two-dimensional images 82 and 83 of the environment (step S105).

Then, the controller 3 determines whether a simulation execution operation has been made (step S106). When no simulation execution operation has been made (No at step S106), the controller 3 repeats the determination at step S106 until the simulation execution operation is made.

When the controller 3 determines that a simulation execution operation has been made (Yes at step S106), the controller 3 displays the simulation image 8 combined at step S105 (step S107). Then, the controller 3 determines whether there is an interference between the robot 110 and the environment in the simulation image 8 (step S108).

When the controller 3 determines that there is an interference (Yes at step S108), the controller 3 makes a notification of the interference (step S111). Then, the processing moves to step S109. When the controller 3 determines that there is no interference (No at step S108), the controller 3 determines whether a viewpoint changing operation has been made (step S109).

When the controller 3 determines that a viewpoint changing operation has been made (Yes at step S109), the controller 3 changes the viewpoint employed in the simulation image 8 (step S112). Then, the processing moves to step S110.

When the controller 3 determines that no viewpoint changing operation has been made (No at step S109), the controller 3 determines whether a simulation ending operation has been made (step S110). When the controller 3 determines that no simulation ending operation has been made (No at step S110), the processing moves to step S107. When the controller 3 determines that a simulation ending operation has been made (Yes at step S110), the processing ends.

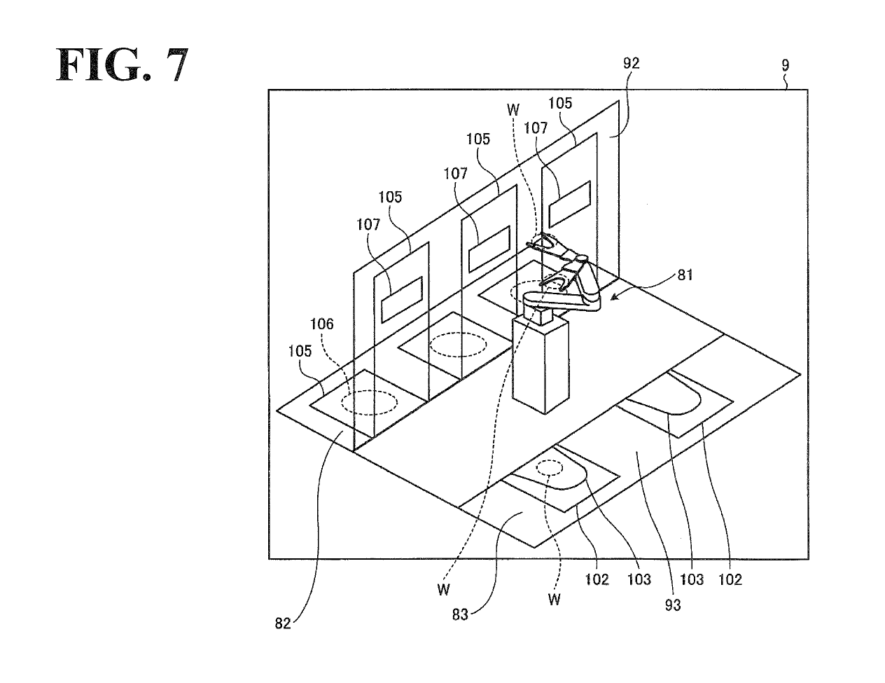

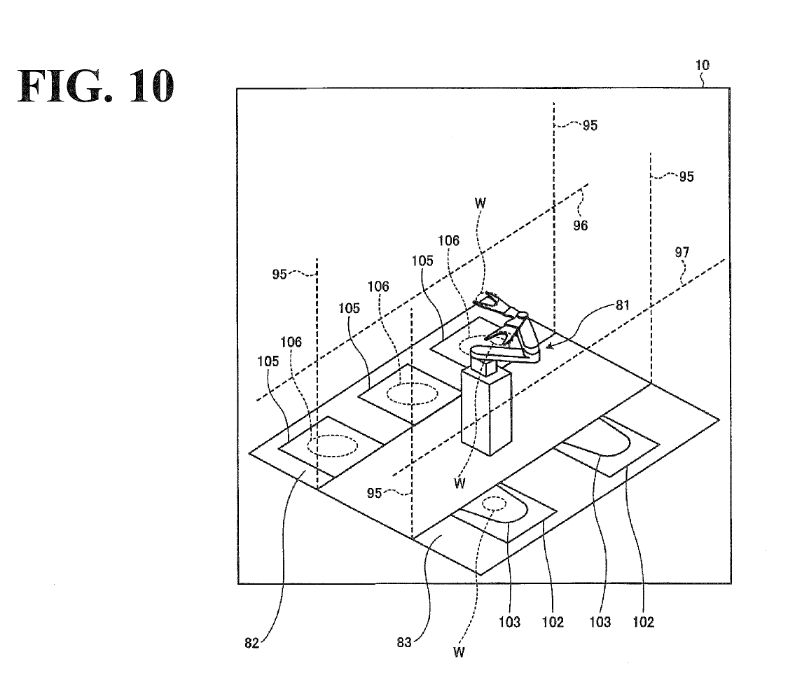

It is noted that the simulation images 8 and 80 according to this embodiment are provided for exemplary purposes only and open to various modifications. Next, simulation images 9, 90, and 91 according to modification 1 of the embodiment will be described by referring to FIGS. 7 to 9. Then, a simulation image 10 according to modification 2 of the embodiment will be described by referring to FIG. 10.

FIGS. 7 to 9 respectively illustrate the simulation images 9, 90, and 91 according to modification 1 of the embodiment. FIG. 10 illustrates the simulation image 10 according to modification 2 of the embodiment. In the following description, like reference numerals designate corresponding or identical elements throughout FIGS. 4 and 7 to 10, and these elements will not be elaborated.

The robot simulator 1 may store in the storage 4, for example, a two-dimensional image representing the inside surface of the clean room 101, in addition to the two-dimensional images 82 and 83. This ensures a closer-to-real representation of the environment of the robot 110.

Specifically, as illustrated in FIG. 7, the robot simulator 1 may display the simulation image 9. The simulation image 9 is an image of a two-dimensional image 92 combined with the three-dimensional image 81 of the robot 110 and the two-dimensional images 82 and 83 of the environment. The two-dimensional image 92 represents the inside surface of the clean room 101.

Thus, the robot simulator 1 uses the simulation image 9 to provide a closer-to-real representation of the environment of the robot 110. Thus, the robot simulator 1 further makes it easier to have an image of an actual movement of the robot 110 while preventing a significant increase in the processing load necessary for image generation.

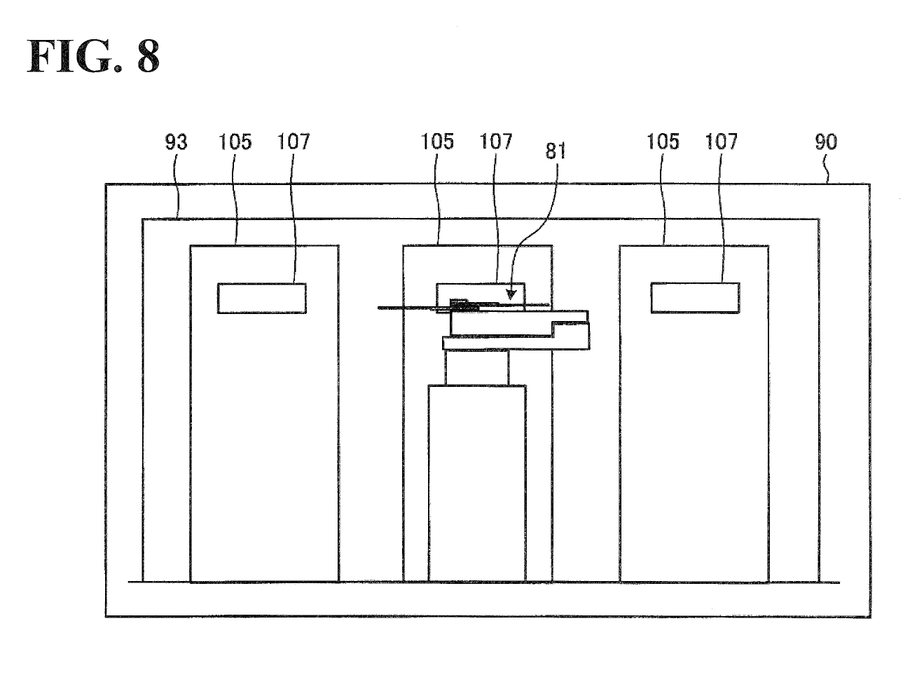

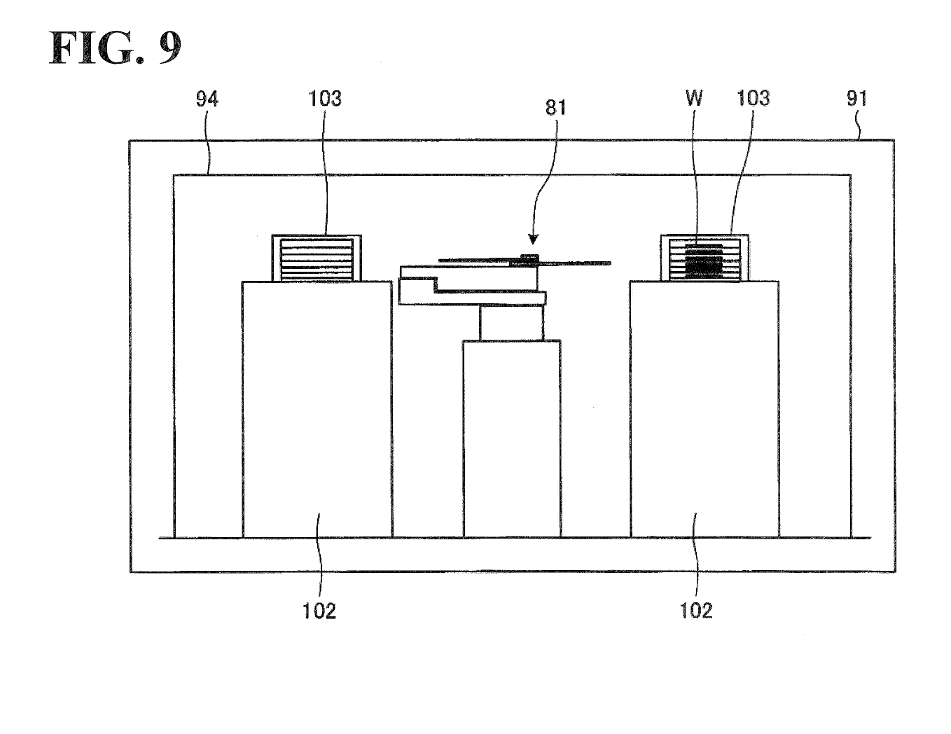

While the simulation image 9 illustrated in FIG. 7 is displayed, when the robot simulator 1 receives a viewpoint changing operation to orient the viewpoint to a horizontal direction, for example, then the robot simulator 1 may display the simulation image 90 illustrated in FIG. 8 or the simulation image 91 illustrated in FIG. 9.

Specifically, as illustrated in FIG. 8, the robot simulator 1 may display the simulation image 90. The simulation image 90 is an image of a two-dimensional image 93 of the processing chambers 105 combined with the three-dimensional image 81 of the robot 110 viewed from the FOUP 103 side.

Thus, the robot simulator 1 facilitates checking for an interference in the simulation image 90 between, for example, the conveyance windows 107 of the processing chambers 105 and the first hand 115 and the second hand 116 in motion.

As illustrated in FIG. 9, the robot simulator 1 may display the simulation image 91. The simulation image 91 is an image of a two-dimensional image 94 of the FOUPs 103 and the tables 102 combined with the three-dimensional image 81 of the robot 110 viewed from the processing chamber 105 side.

Thus, the robot simulator 1 facilitates checking for an interference in the simulation image 91 between, for example, the FOUPs 103 and the first hand 115 and the second hand 116 in motion.

As illustrated in FIG. 10, the robot simulator 1 may display the simulation image 10. The simulation image 10 is an image of four vertical guide lines 95 and horizontal guide lines 96 and 97 combined with the three-dimensional image 81 of the robot 110 and the two-dimensional images 82 and 83 of the environment.

The four vertical guide lines 95 define four corners of the clean room 101. The horizontal guide line 96 indicates the height position of the center of the conveyance window 107 of each processing chamber 105. The horizontal guide line 97 indicates the height position of the opening center of each FOUP 103.

Thus, the robot simulator 1 displays the simulation image 10 to make it easier to have an image of the environment of the robot 110 while reducing the processing load necessary for image generation.

It is also possible for the robot simulator 1 to lay marks such as circles over the center positions of the conveyance windows 107 on the horizontal guide line 96 and over the opening center positions of the FOUPs 103 on the horizontal guide line 97. Thus, the robot simulator 1 further makes it easier to have an image of the environment of the robot 110.

As has been described hereinbefore, the robot simulator according to this embodiment includes the image generator and the display controller. The image generator generates a three-dimensional robot image representing a movement to be taught to the robot. The display controller combines a two-dimensional image representing an environment of the robot with the three-dimensional robot image generated by the image generator so as to obtain a combined image, and controls the display to display the combined image. Thus, the robot simulator makes it easier to have an image of an actual movement of the robot while reducing the processing load necessary for image generation.

The robot simulator according to this embodiment includes the operator and the storage. The operator receives an operation of input of a parameter that is related to the robot and that is to be applied to the three-dimensional robot image. The storage stores the two-dimensional image. The image generator generates the three-dimensional robot image to which the parameter input by the operator is applied.

The display controller combines the two-dimensional image stored in the storage with the three-dimensional robot image to which the parameter is applied. Thus, the robot simulator uses the two-dimensional image stored in the storage to represent the environment of the robot in the simulation image. This further reduces the processing load necessary for image generation.

Additionally, the robot simulator applies parameters of the actual robot to the three-dimensional robot image. This ensures display of a simulation image that represents the actual movement of the robot with improved fidelity.

The two-dimensional image according to this embodiment is a top view of the environment of the robot. Thus, in order to represent the environment of the robot, the robot simulator displays a minimum piece of information necessary for the checking of robot movement.

The display controller according to this embodiment lays the two-dimensional image representing the environment of the robot over the surface on which the robot is installed in the three-dimensional robot image. Thus, the robot simulator removes from the simulation image the walls of the clean room and other obstacles to the checking of robot movement in the simulation image. Thus, the robot simulator uses the three-dimensional robot image to provide a clearer image of the movement of the robot.

The display controller according to this embodiment performs image processing to change the viewpoint employed in the two-dimensional image in accordance with the viewpoint employed in the three-dimensional robot image. Thus, the robot simulator ensures a negligible sense of uncomfortability that the user might have about the simulation image.

The display controller according to this embodiment performs image processing to change the viewpoint employed in the three-dimensional robot image. Thus, the robot simulator changes the viewpoint employed in the two-dimensional image representing the environment in accordance with the change in the viewpoint employed in the three-dimensional robot image.

Thus, the robot simulator changes the viewpoint employed in the simulation image to a vertically upward viewpoint or to a horizontal viewpoint. This facilitates checking for an interference with the robot and the environment in the simulation image.

In the embodiment, the simulation image is displayed both on the display of the manual operator and the display device. It is also possible to display the simulation image on either the display of the manual operator or the display device. All the various kinds of information necessary for the simulation may be input by either the operator of the manual operator or the operator of the robot simulator.

In the embodiment, the two-dimensional image representing the environment of the robot is stored in advance in the storage. The robot simulator may also generate the two-dimensional image representing the environment of the robot based on parameters of the environment input externally. Thus, the robot simulator combines into the simulation image a two-dimensional image representing any environment that depends on the environment parameters input externally.

The robot simulator may lay access points of the robot over each of the simulation images. Thus, the robot simulator enables the user to check the movement of the robot more accurately.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A robot simulator comprising:
an image generator configured to generate a three-dimensional robot image representing a movement to be taught to a robot; and
a display controller configured to combine a two-dimensional image representing an environment of the robot with the three-dimensional robot image generated by the image generator so as to obtain a combined image, and configured to control a display to display the combined image.

2. The robot simulator according to claim 1, further comprising:
an operator configured to receive an operation of input of a parameter that is related to the robot and that is to be applied to the three-dimensional robot image; and
a storage configured to store the two-dimensional image,
wherein the image generator is configured to generate the three-dimensional robot image to which the parameter input by the operator is applied, and
wherein the display controller is configured to combine the two-dimensional image stored in the storage with the three-dimensional robot image to which the parameter is applied.

3. The robot simulator according to claim 1, wherein the two-dimensional image comprises a top view of the environment.

4. The robot simulator according to claim 1, wherein the display controller is configured to lay the two-dimensional image over a surface on which the robot is installed in the three-dimensional robot image.

5. The robot simulator according to claim 1, wherein the display controller is configured to perform image processing to change a viewpoint employed in the two-dimensional image in accordance with a viewpoint employed in the three-dimensional robot image.

6. The robot simulator according to claim 1, wherein the display controller is configured to perform image processing to change a viewpoint employed in the three-dimensional robot image.

7. A robot simulation method comprising:
generating a three-dimensional robot image representing a movement to be taught to a robot; and
combining a two-dimensional image representing an environment of the robot with the three-dimensional robot image so as to obtain a combined image and controlling a display to display the combined image.

8. A robot simulation program for causing a computer to execute processing comprising:
generating a three-dimensional robot image representing a movement to be taught to a robot; and
combining a two-dimensional image representing an environment of the robot with the three-dimensional robot image so as to obtain a combined image and controlling a display to display the combined image.

9. The robot simulator according to claim 2, wherein the two-dimensional image comprises a top view of the environment.

10. The robot simulator according to claim 2, wherein the display controller is configured to lay the two-dimensional image over a surface on which the robot is installed in the three-dimensional robot image.

11. The robot simulator according to claim 3, wherein the display controller is configured to lay the two-dimensional image over a surface on which the robot is installed in the three-dimensional robot image.

12. The robot simulator according to claim 9, wherein the display controller is configured to lay the two-dimensional image over a surface on which the robot is installed in the three-dimensional robot image.

13. The robot simulator according to claim 2, wherein the display controller is configured to perform image processing to change a viewpoint employed in the two-dimensional image in accordance with a viewpoint employed in the three-dimensional robot image.

14. The robot simulator according to claim 3, wherein the display controller is configured to perform image processing to change a viewpoint employed in the two-dimensional image in accordance with a viewpoint employed in the three-dimensional robot image.

15. The robot simulator according to claim 4, wherein the display controller is configured to perform image processing to change a viewpoint employed in the two-dimensional image in accordance with a viewpoint employed in the three-dimensional robot image.

16. The robot simulator according to claim 9, wherein the display controller is configured to perform image processing to change a viewpoint employed in the two-dimensional image in accordance with a viewpoint employed in the three-dimensional robot image.

17. The robot simulator according to claim 10, wherein the display controller is configured to perform image processing to change a viewpoint employed in the two-dimensional image in accordance with a viewpoint employed in the three-dimensional robot image.

18. The robot simulator according to claim 11, wherein the display controller is configured to perform image processing to change a viewpoint employed in the two-dimensional image in accordance with a viewpoint employed in the three-dimensional robot image.

19. The robot simulator according to claim 12, wherein the display controller is configured to perform image processing to change a viewpoint employed in the two-dimensional image in accordance with a viewpoint employed in the three-dimensional robot image.

20. The robot simulator according to claim 2, wherein the display controller is configured to perform image processing to change a viewpoint employed in the three-dimensional robot image.
